(19) United States
(12) Patent Application Publication
(10) Pub. No.: US 2017/0270488 A1
(43) Pub. Date: Sep. 21, 2017

(54) PRIVILEGE-BASED TASK PROCESSING AT A VIRTUAL ASSISTANT

(71) Applicant: Microsoft Technology Licensing, LLC, Redmond, WA (US)

(72) Inventors: William Alexander Spencer, JR., Redmond, WA (US); Andres Monroy-Hernandez, Seattle, WA (US); Justin Brooks Cranshaw, Seattle, WA (US)

(21) Appl. No.: 15/071,175

(22) Filed: Mar. 15, 2016

(51) Int. Cl. G06Q 10/10

(52) U.S. Cl. CPC G06Q 10/1097

(57) ABSTRACT

Aspects extend to methods, systems, and computer program products for privilege-based task processing at a virtual assistant. An owner of a virtual assistant can assign other users privileges for interacting with the owner's calendar through the virtual assistant. To establish user privileges, the owner can enter information about himself or herself, including user permissions, into a Privileged Associates Database (“PAD”). An administrator can also configure some or all of this privileged associate(s) information to be entered automatically in the PAD. As such, a privileged associate can request that the virtual assistant schedule an event on the owner's calendar. In response, the virtual assistant refers to the PAD and checks privileges. The virtual assistant automatically synthesizes a response accordingly (e.g., scheduling the event, displaying schedule information, requesting owner confirmation, preventing the request, etc.) based on the owner's schedule and the associate's privileges.

### CROSS-REFERENCE TO RELATED APPLICATIONS

Not Applicable.

### BACKGROUND

### 1. Background and Relevant Art

Computer systems and related technology affect many aspects of society. Indeed, the computer system's ability to process information has transformed the way we live and work. More recently, computer systems have been coupled to one another and to other electronic devices to form both wired and wireless computer networks over which the computer systems and other electronic devices can transfer electronic data. Accordingly, the performance of many computing tasks is distributed across a number of different computer systems and/or a number of different computing environments. For example, distributed applications can have components at a number of different computer systems.

In some environments, virtual assistants have been used to improve productivity for individual users. Through voice, gesture, email, text etc. a calendar owner can schedule an event (e.g. appointment, task, meeting, reminder, etc.) on her/his calendar. A virtual assistant for a calendar owner can also permit other users to request events be scheduled on the calendar owner's calendar.

However, these virtual assistants are inferior to a dedicated human assistant in a number of ways. For example, a virtual assistant has no knowledge of the relationships between a calendar owner and a subset of associates that are the calendar owner's co-workers, family and friends. Further, a virtual assistant has now knowledge of relationships between a calendar owner and a domain of associates, such as, for example, if the calendar owner is a teacher and her/his students are looking to schedule a meeting during specified office hours. Additionally, a virtual assistant may have no way to distinguish solicitors, such as, for example, sales people or potential customers, with whom the calendar owner may be open to schedule calls, but only at specified times

As a result, a virtual assistant typically lacks the ability for scheduling preference or special handling for privileged associates, such as, for example, a calendar owner's manager, project collaborator, spouse, partner, parents, children, friends and health care providers or associates communicating from a specific domain in contrast to a class of unknown users.

### BRIEF SUMMARY

Examples extend to methods, systems, and computer program products for privilege-based task processing at a virtual assistant. In some aspects, a scheduling agent processes a request to perform a scheduling related task on the calendar of a calendar owner. A request to perform a scheduling-related task on the calendar owner's calendar is received from another user.

A privileged associates database for the calendar owner is accessed. The privileged associates database defines permissions for others to use the scheduling agent to perform scheduling related tasks for the calendar owner. Privileges for the other user are determined by referring to the defined permissions. The privileges indicate if the other user can use the scheduling agent to perform the requested scheduling-related task for the calendar owner. The request to perform the scheduling-related task is responded to in accordance with the calendar owner's schedule and determined privileges for the other user.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by practice. The features and advantages may be realized and obtained by means of the instruments and combinations particularly pointed out in the appended claims. These and other features and advantages will become more fully apparent from the following description and appended claims, or may be learned by practice as set forth hereinafter.

### BRIEF DESCRIPTION OF THE DRAWINGS

In order to describe the manner in which the above-recited and other advantages and features can be obtained, a more particular description will be rendered by reference to specific implementations thereof which are illustrated in the appended drawings. Understanding that these drawings depict only some implementations and are not therefore to be considered to be limiting of its scope, implementations will be described and explained with additional specificity and detail through the use of the accompanying drawings in which:

FIG. 1 illustrates an example architecture that facilitates privilege-based task processing at a virtual assistant.

FIG. 2 illustrates a flow chart of an example method for privilege-based task processing at a virtual assistant.

FIG. 3 illustrates an example architecture that facilitates automated task processing.

### DETAILED DESCRIPTION

Examples extend to methods, systems, and computer program products for privilege based task processing at a virtual assistant. In some aspects, a scheduling agent processes a request to perform a scheduling related task on the calendar of a calendar owner. A request to perform a scheduling related task on the calendar owner's calendar is received from another user.

A privileged associates database for the calendar owner is accessed. The privileged associates database defines permissions for others to use the scheduling agent to perform scheduling-related tasks for the calendar owner. Privileges for the other user are determined by referring to the defined permissions. The privileges indicate if the other user can use the scheduling agent to perform the requested scheduling-related task for the calendar owner. The request to perform the scheduling-related task is responded to in accordance with the calendar owner's schedule and determined privileges for the other user.

Implementations may comprise or utilize a special purpose or general-purpose computer including computer hardware, such as, for example, one or more processors (including Central Processing Units (CPUs) and/or Graphical Processing Units (GPUs)) and system memory, as discussed in greater detail below. Implementations also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of can comprise at least two distinctly different kinds of computer-readable media: computer storage media (devices) and transmission media.

Computer storage media (devices) includes RAM, ROM, EEPROM, CD-ROM, Solid State Drives (“SSDs”) (e.g., RAM-based or Flash-based), Shingled Magnetic Recording (“SMR”) devices, Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

In one aspect, one or more processors are configured to execute instructions (e.g., computer-readable instructions, computer-executable instructions, etc.) to perform any of a plurality of described operations. The one or more processors can access information from system memory and/or store information in system memory. The one or more processors can transform information between different formats, such as, for example, between permissions, read requests, scheduling requests, notifications, confirmations, calendar updates, calendar data, automated task formats, micro-task formats, and macro-tasks format.

System memory can be coupled to the one or more processors and can store instructions (e.g., computer-readable instructions, computer-executable instructions, etc.) executed by the one or more processors. The system memory can also be configured to store any of a plurality of other types of data generated and/or transformed by the described components, such as, for example, permissions, read requests, scheduling requests, notifications, confirmations, calendar updates, calendar data, automated task formats, micro-task formats, and macro-tasks format as well as results generated by performing automated tasks, micro-tasks, and macro-tasks.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, in response to execution at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the described aspects may be practiced in network computing environments with many types of computer system configurations, including, personal computers, desktop computers, laptop computers, message processors, hand-held devices, wearable devices, multicore processor systems, multi-processor systems, microprocessor-based or programmable consumer electronics, network PCs, minicomputers, mainframe computers, mobile telephones, PDAs, tablets, pagers, watches, fitness monitors, eye glasses, routers, switches, and the like. The described aspects may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The described aspects can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources (e.g., compute resources, networking resources, and storage resources). The shared pool of configurable computing resources can be provisioned via virtualization and released with low effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the following claims, a “cloud computing environment” is an environment in which cloud computing is employed.

Aspects of the invention enable a calendar owner to assign other users privileges for interacting with the calendar owner's calendar through a virtual assistant. A calendar owner can identify a list of privileged users who can create events on the calendar owner's calendar with greater privileges than that given to other associates. The calendar owner can identify a domain of users (e.g., nd.edu) who can schedule meetings during specific hours (e.g. weekly office hours). The calendar owner can specify hours for solicitors to schedule events (e.g. new customer inquiries or solicitors at certain hours of the work day).

In one aspect, privileges for read access to the calendar owner's calendar are given to one or more other users. Thus, by user specification, privileged associates may also be given a snapshot of the calendar owner's calendar by day, week or month, at the level of event details, just free and busy time, location, or events at a specific day and time.

A virtual assistant can have an identifier unique to the calendar owner. The calendar owner can configure communications related to scheduling to go to the virtual assistant. The identifier for the virtual assistant can be similar to but somewhat different that the identifier for the calendar owner. For example, an identifier for a calendar owner may be ada@xyz.org and the identifier for the calendar owner's virtual assistant may be ada1234@xyz.org. In one aspect, the virtual assistant is an alternate contact for the calendar owner for scheduling purposes. As such, other users (e.g., privileged associates, associates within specific domains, and solicitors) can communicate electronically with the calendar owner's virtual assistant as they may with a human assistant assigned to support the calendar owner.

Accordingly, to calendar owners and those they invite to a meeting, a virtual assistant can provide the illusion of being a human assistant, working unseen but responding to electronic communication (including mail, text, gesture, and voice command) A virtual assistant can be implemented by several computer servers, automated software, and, optionally, human workers who interact with a virtual assistant system via web-based applications.

To establish user privileges, a calendar owner can enter information about himself or herself, including user permissions, into a Privileged Associates Database (“PAD”). The user permissions can define, privileged associates, such as the calendar owner's manager, project collaborator, spouse, partner, parents, children, friends and/or health care providers. Thus, the PAD can store a list of privileged associates, domain, and/or solicitor access and their corresponding user-specified privileges and contact information. Contact information can include email address(es), phone number(s), and/or similar identifiers used for electronic communication.

As such, a privileged associate can request that the virtual assistant schedule an event on the calendar owner's calendar. In response, the virtual assistant refers to the PAD and checks privileges. The virtual assistant automatically responds accordingly (e.g., scheduling the event, displaying schedule information, requesting user confirmation, preventing the request, etc.)

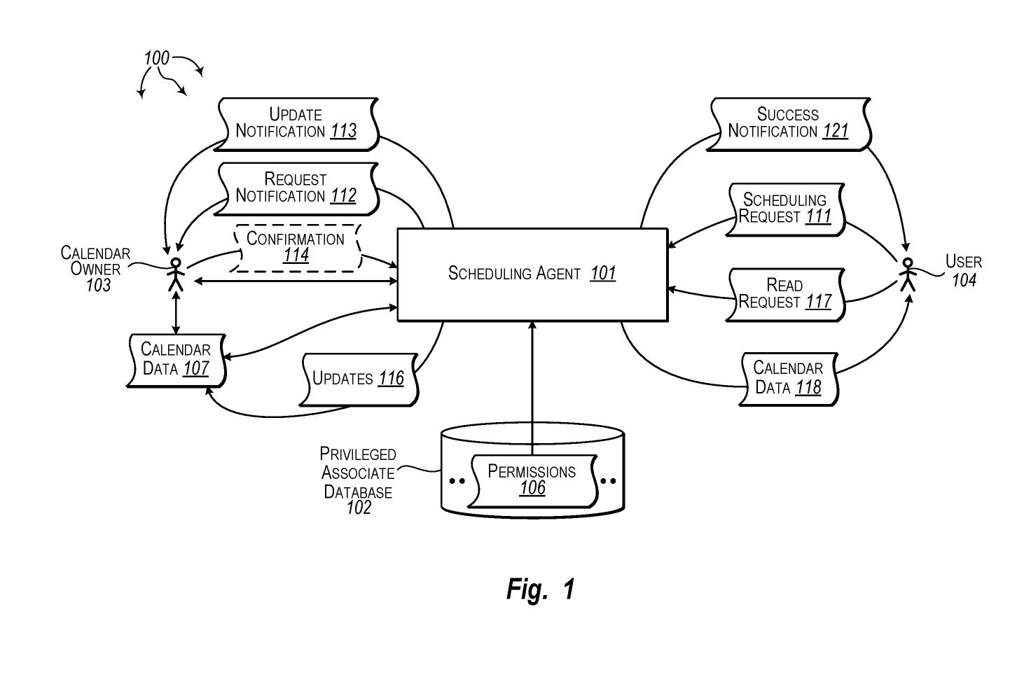

FIG. 1 illustrates an example computer architecture 100 that facilitates privilege-based task processing at a virtual assistant. Referring to FIG. 1, computer architecture 100 includes scheduling agent 101, Privileged Associates Database (PAD) 102, calendar owner 103, and user 104. Scheduling agent 101, Privileged Associates Database (PAD) 102, calendar owner 103, and user 104 can be connected to (or be part of) a network, such as, for example, a Local Area Network (“LAN”), a Wide Area Network (“WAN”), and even the Internet. Accordingly, scheduling agent 101, Privileged Associates Database (PAD) 102, calendar owner 103, and user 104 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (SOAP), etc. or using other non-datagram protocols) over the network.

Privileged Associates Database (PAD) 102 can store permissions for one or more calendar owners, including permissions 106 for calendar owner 103. Calendar owner 103 (the owner of calendar data 107) can establish permissions 106 by entering information about himself or herself as well as information about privileged associates into PAD 102. In other aspects, an administrator can configure at least some (and possibly all) information to be automatically entered into PAD 102.

Calendar owner 103 can enter parameters including contact information such as, for example, email address(es), phone number(s), etc. for electronic communication with calendar owner 103 in to permissions 106. Parameters in permissions 106 can define privileged (as well as blocked) associates of calendar owner 103. Privileged associates can include any of: calendar owner 103's manager(s), calendar owner 103's direct report(s), calendar owner 103's team members(s), project collaborators with calendar owner 103, calendar owner 103's spouse, calendar owner 103's partner(s), calendar owner 103's children, calendar owner 103's friends, etc. Thus, for calendar owner 103, PAD 102 can store a list of privileged associates, domain, and/or solicitor access and their corresponding user-specified privileges and contact information. Permissions 106 can include date and time parameters granting and/or denying specified associates and/or specified groups of associate access to update and/or read calendar 107 at specified dates and/or times.

PAD 102 can be any of a variety of different types of databases including a stand-alone database, a distributed database, a directory (e.g., an active directory), etc.

In general, scheduling agent 101 is configured to assist with completing scheduling tasks for calendar owner 103 (and possibly one or more other users). Scheduling agent 101 can receive electronic communication (e.g., email, text, voice command, gesture or other) from another user (e.g., user 104) requesting performance of a task for calendar owner 103. Scheduling agent 101 can route the electronic communication to a process that categorizes the request as coming from a privileged user, a blocked user, member of a privileged domain and/or solicitor associated with calendar owner 103. Based on the categorization (and possibly also date and time parameters), scheduling agent 101 can refer to permissions 106 to determine if the other user is permitted to perform the task for calendar owner 103. Scheduling agent 101 can be integrated into a calendar program used by calendar owner 103 and configured to enter updates to calendar data.

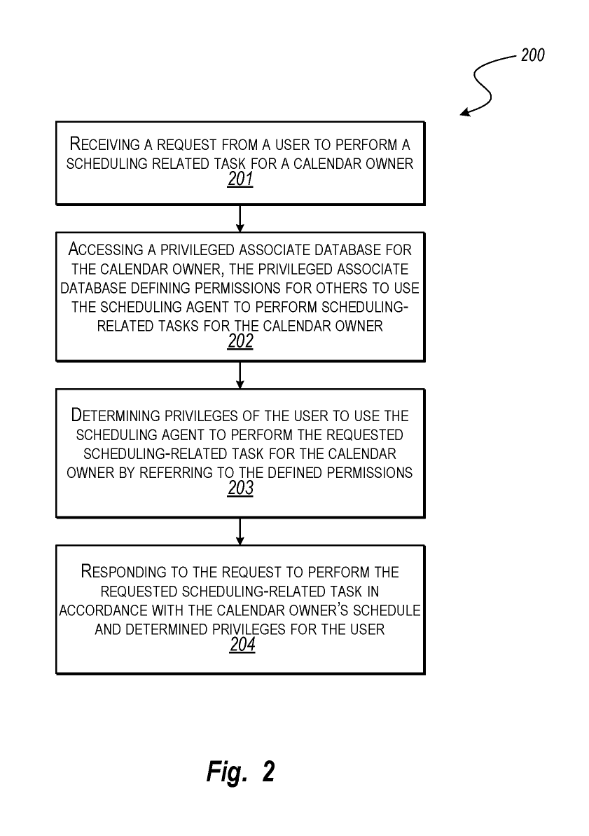

FIG. 2 illustrates a flow chart of an example method for privilege-based task processing at a virtual assistant. Method 200 will be described with respect to the components and data of computer architecture 100.

Method 200 includes receiving a request from a user to perform a scheduling-related task for a calendar owner (201). For example, scheduling agent 101 can receive scheduling request 111 from user 104. Scheduling request 111 can be a request to perform a scheduling related task for calendar owner103 (e.g., adding an event to the calendar of calendar owner 103).

Method 200 includes accessing a privileged associates database for the calendar owner, the privileged associates database defining permissions for others to use the scheduling agent to perform scheduling-related tasks for the calendar owner (202). For example, scheduling agent 101 can access permissions 106 from PAD 102. As described, permissions 106 define permissions for others to use scheduling agent 101 to perform scheduling related tasks for calendar owner 103

Method 200 includes determining privileges of the user to use the scheduling agent to perform the requested scheduling-related task for the calendar owner by referring to the defined permissions (203). For example, scheduling agent 101 can refer to permissions 106 to determine privileges of user 104 to perform the scheduling task requested for calendar owner 103 by scheduling request 111 (e.g., adding an event to calendar data 107).

Method 200 includes responding to the request to perform the requested scheduling-related task in accordance with the calendar owner's schedule and determined privileges for the user (204). For example, scheduling agent 101 can respond to scheduling request 111 in accordance with calendar owner 103's schedule (e.g., as indicated in calendar data 107) and the determined privileges (from permissions 106) for user 104.

In one aspect, responding to a request to perform a scheduling-related task includes automatically, and without user intervention, synthesizing a multi-data response to the request by transforming the request, the calendar owner's schedule, and determined privileges for the user into the multi-data response. For example, scheduling request 111, calendar data 107, and permissions 106 can be transformed into a multi-data response that includes essentially simultaneously formulating at least one, and possibly two or more, of: updates 116, update notification 113, and success notification 121. The various notifications and updates can be delivered and/or applied (e.g., in parallel) to appropriate parties and/or calendar data to implement the multi-data response. Other forms of data can also be synthesized into a multi-data response, including but not limited to: calendar data, request notifications, asynchronous communication from other task agents, asynchronous communication related to micro-tasks and/or macro-tasks, etc.

In some aspects, user 104 is permitted to perform scheduling-related tasks for calendar owner 103. When user 104 is permitted to perform scheduling related tasks for calendar owner 103, scheduling agent 101 can check calendar data 107 for any conflicts with the requested scheduling-related task. For example, scheduling agent 101 can determine if calendar owner 103 already has an event at a requested date and time. When there is a conflict, scheduling agent 101 can notify calendar owner 103 and/or user 104 of the conflict. In response, calendar owner 103 and/or 104 can propose a new time.

When there is no conflict, scheduling agent 101 can enter update 116 to calendar data 107 to implement scheduling request 111 (e.g., adding an event to the calendar of calendar owner 103). In one aspect, scheduling agent 101 automatically enters update 116 to calendar data 107. Thus, scheduling agent 101 implements scheduling request 111 without further input calendar owner 103.

In another aspect, based at least in part on permissions 106, scheduling agent 101 sends request notification 112 to notify calendar owner 103 of scheduling request 111. In response to request notification 112, calendar owner 103 can send confirmation 114 to scheduling agent 101. Upon receiving confirmation 114, scheduling agent 101 enters update 116 to calendar data 107 to implement scheduling request 111. In this other aspect, if calendar owner 103 does not respond to request notification 112, update 116 is not entered into calendar data 107.

Based on permissions 106, scheduling agent 101 can notify calendar owner 103 and/or user 104 when update 116 is entered. For example, scheduling agent 101 can send update notification 113 to calendar owner 103 and/or can send success notification 121 to user 104.

In a further aspect, based at least in part on permissions 106, user 104 is not permitted to perform scheduling-related tasks for calendar owner 103. When user 104 is not permitted to perform scheduling-related tasks for calendar owner 103, scheduling agent 101 takes no action to update calendar data 107. Scheduling agent 101 can notify calendar owner 103 of the failed attempt to perform scheduling request 111. Scheduling agent 101 can also notify user 104 that scheduling request 111 failed.

In an additional aspect, user 104 may request to read calendar data 107 to determine if calendar owner 103 is available at a specified date and time. User 104 can send read request 117 to scheduling agent 101. Scheduling agent 101 can check permissions 106 in PAD 102 to determine if user 104 is permitted to view calendar owner 103's calendar. When user 104 is permitted to view calendar owner 103's calendar, scheduling agent 101 can send calendar data 118 (a portion of calendar data 107) to user 104. When user 104 is not permitted to view calendar owner 103's calendar, scheduling agent 101 can notify user 104 that he or she lacks permissions to view calendar owner 103's calendar.

A calendar owner can assign one or more different tiers of privilege to one or more privileged associates, domains, and/or solicitors by defining permissions in a PAD. For example, a calendar owner can give another user the ability to schedule all event types on the calendar owner's calendar, provided there are no conflicts, without event-specific approval from the calendar owner. A calendar owner can give another user the ability to schedule specific event types on the calendar owner's calendar, provided there are no conflicts, without event-specific approval from the calendar owner. A calendar owner can give another user the ability to schedule all event types on the calendar owner's calendar, regardless of conflicts, without event-specific approval from the calendar owner. A calendar owner can give another user the ability to schedule specific vent types on the calendar owner's calendar, regardless of conflicts, without event-specific approval from the calendar owner. A calendar owner can give another user the ability to schedule all or specific events on the calendar owner's calendar during specific hours or days of the week without approval from the calendar owner. A calendar owner can give another user the ability to schedule all or specific events on the calendar owner's calendar during specific hours or days of the week with approval from the calendar owner.

A calendar owner can also assign privileged associates, domains, and/or solicitors the ability to view his or her calendar by defining permissions in a PAD. A calendar view can include one or more of: a snapshot of the calendar owner's calendar by day, week or month, at the level of event details, just free and busy time, location (e.g. ‘user is in <usual location, a given city, state/province, or country> for <a given period of> days), or events at a specific day and time.

As described, a scheduling agent can also utilize one or more forms of notification. A scheduling agent can notify a requesting user of a general conflict on a calendar owner's calendar when attempting to schedule an event for the calendar owner. A scheduling agent can notify a requesting user of a specific conflict on a u calendar owner's calendar when attempting to schedule an event for the calendar owner. A scheduling agent can notify a requesting user and a calendar owner when an event is scheduled for the calendar owner. A scheduling agent can notify a calendar owner of any conflicts and a requesting user who added or attempted to add an event to the calendar owner's schedule.

Thus, parameters can be used to define permissions within a PAD at various levels of complexity. A calendar user enter parameters defining rules as well as exceptions within permissions contained in a PAD. For example, a calendar owner may accept solicitations at various times of day but can block particular users for which prior meetings were unproductive. A calendar owner may also, in general, accept meeting requests from a particular domain but may block specific individuals within the domain. Exceptions can include time and date parameters, where otherwise blocked individuals may be permitted to schedule meetings or read calendar (o vice versa).

In one aspect, through automation, a scheduling agent processes relatively complex permissions and responds to a request in a manner much more efficient than possible by a human assistant. For example, the scheduling agent synthesizes a response to a meeting request based on a received scheduling request, the user that sent the scheduling request, and the contents of a PAD. The scheduling agent can transform the scheduling request and permissions contained in the PAD into a calendar update and/or notification in view of a user requesting a meeting with a calendar owner. For example, scheduling agent 101 can synthesize updates 116 and/or update notification 113 by transforming permissions 106 and scheduling request 111 into updates 116 and/or update notification 113 in view of user 104.

Accordingly, a virtual assistant (e.g., scheduling agent 101) can relieve a calendar owner from having to perform a variety of manual operations related to calendar management and can do so in a manner that is more efficient than a human assistant. For example, a virtual assistant can process and respond to a meeting request according to a calendar owner's instructions based on the party that sent the meeting request in a fully automated manner. The virtual assistant can track and modify information in a PAD as a calendar owner's relationship with associates’ changes.

Aspects of the invention can process tasks taking advantage of machine learning and micro tasks with mechanisms to escalate micro tasks to micro workers and escalate tasks to macro workers to appropriately solve problems. An overall task to be achieved (e.g., scheduling a meeting between multiple participants) can be broken down into a grouping of (e.g., loosely-coupled) asynchronous sub-tasks (e.g., micro tasks). Completing the grouping of sub-tasks completes the overall task. Execution of tasks is handled by a workflow engine. The workflow engine can process sub-tasks serially and/or in parallel based on inputs to and results from other sub-tasks.

Performance of sub-tasks (e.g., micro tasks) for an overall task can be automated as appropriate based on machine learning from prior performance of the task and/or prior performance related tasks. Sub-tasks (e.g., micro tasks) that are not automatable can be escalated to micro workers (e.g., less skilled workers, crowd-sourced unskilled workers, etc.). When a micro worker performs a sub-task (e.g., a micro task), results from performance of the sub-task can be used as feedback to train the machine learning.

When a micro worker is unable to perform a sub-task (e.g., a micro task), the overall task can be escalated to a macro worker (e.g., a trained worker, a worker with improved language skills, a worker with cultural knowledge) etc. The macro worker can perform the overall task. For example, when scheduling a meeting, a macro work can identify meeting participants, a desired meeting time, duration, location, and subject. The macro worker can mail to any meeting participant or send a meeting invitation. When a sub-task (e.g., micro task) is waiting for human input, the macro task worker can make the sub-task as pending and go on to other sub-tasks.

The sub-task can be monitored and the macro task can be reactivated when there is more work to be done. Sub-tasks can be restarted when they have waited too long. A macro worker can send a reminder that a response is requested.

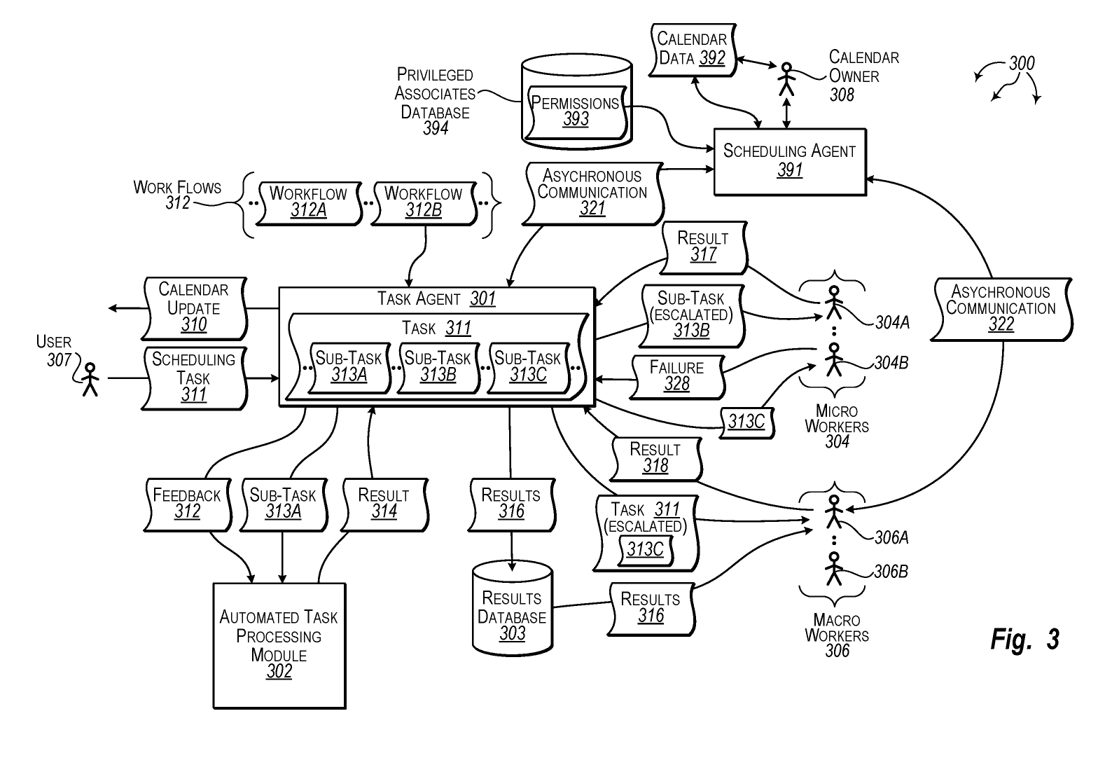

Turning to FIG. 3, FIG. 3 illustrates an example architecture that facilitates automated task processing. Referring to FIG. 3, computer architecture 300 includes task agent 301, automated task processing module 302, results database 303, micro workers 304, macro workers 306, user 307, scheduling agent 391, Privileged Associates Database (PAD) 394, and calendar owner 308. Task agent 301, automated task processing module 302, results database 303, micro workers 304, macro workers 306, user 307, scheduling agent 391, Privileged Associates Database (PAD) 394, and calendar owner 308 can be connected to (or be part of) a network, such as, for example, a Local Area Network (“LAN”), a Wide Area Network (“WAN”), and even the Internet. Accordingly, task agent 301, automated task processing module 302, results database 303, micro workers 304, macro workers 306, user 307, scheduling agent 391, Privileged Associates Database (PAD) 394, and calendar owner 308, as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (SOAP), etc. or using other non-datagram protocols) over the network.

As depicted, micro workers 304 includes micro works 304A, 304B, etc. Micro workers 304 can be human workers physically located in one or more different geographic locations. In general, micro workers 304 are able to handle less complex tasks (e.g., sub-tasks). Micro workers 304 can be less skilled workers (e.g., than macro workers 304), crowd-sourced unskilled workers, etc.

Macro workers 306 includes macro workers 306A, 306B, etc. Macro workers 306 can be human workers physically located in one or more different geographic locations and located at the same or different geographic locations than any of micro workers 304. In general, macro workers 304 are able to handle more complex tasks (e.g., overall scheduling tasks). Macro workers 306 can be trained workers, workers with improved language skills, workers with cultural knowledge, etc.

Workflows 312 includes workflows 312A, 312B, etc. Each of workflows 312 defines a plurality of sub-tasks to be completed to perform a task. That is, a workflow breaks down an overall task into a plurality of (less complex) sub-tasks, which when completed completes the overall task. Sub-tasks can include routing sub-tasks, get attendees sub-tasks, get duration sub-tasks, get subject sub-tasks, get location sub-tasks, get conference call dial-in or phone number sub-tasks, get meeting times sub-tasks, get response times sub-tasks, etc. Tasks can include scheduling tasks (meetings, events, etc.), travel requests, expense reports, requisitions, etc.

In general, task agent 301 (e.g., a scheduling agent) is configured to assist with completing tasks for user 307 (and possibly one or more other users). In response to receiving a task, task agent 301 can access a workflow from workflows 312 that corresponds to the task.

For each sub-task define in a workflow, task agent 301 can determine if automated task processing module 302 has the capability to automate performance of the sub-task. When automated task processing module 302 has the capability to automate a sub-task, task agent 301 can send the sub-task to automated task processing module 302. Automated task processing module 302 can perform the sub-task (without human intervention). Automated task processing module 302 can return results of performing the sub-task back to task agent 301.

On the other hand, when automated task processing module 302 lacks the capability to automate a sub-task, task agent 301 can automatically escalate the sub-task to a micro worker 304. The micro worker can perform the sub-task and results of performing the sub-task can be returned back to task agent 301.

Automated task processing module 302 can include machine learning components that learn how to handle sub-tasks through feedback from other modules. For example, task agent 301 can use results from micro worker performance of sub-tasks as feedback to train automated task processing module 301. Accordingly, automated processing of sub-tasks can increase over time as automated task processing module 301 is trained to handle additional sub-tasks.

Results from sub-task processing (both automated and micro worker) can be stored in results database 303. During sub-task performance (either automated or micro worker), a sub-task may refer to results from previously performed sub-tasks stored in results database 303. The sub-task can use stored results to make progress in completing.

When a micro worker lacks the capability to perform a sub-task (or cannot perform a sub-task for some other reason), task agent 301 can automatically escalate a task (i.e., an overall task) to a macro worker. To escalate a task to a macro worker, results from performed sub-tasks along with any remaining unperformed sub-tasks can be sent to the macro worker. The macro worker can use results from performed sub-tasks to complete remaining unperformed sub-tasks. Completion of remaining unperformed sub-tasks in turn completes the (overall) task.

Task and sub-task completion can be based on asynchronous communication with one or more entities. For example, when scheduling a meeting, task and sub-task completion can be based on asynchronous communicate with requested meeting participants. Asynchronous communication can include electronic communication, such as, for example, electronic mail, text messaging, etc. For example, a worker can send an electronic mail message requesting that a person attend a meeting. The worker then waits for a response from the person. The worker can send reminder emails if a response is not received within a specified time period.

A workflow can define relationships between sub-tasks such that some sub-tasks are performed serially and others in parallel. Thus, within a workflow, sub-tasks can be performed in serial and/or in parallel. Some sub-tasks can depend on results from other sub-tasks. These sub-tasks can be performed serially so that results can be propagated. Further sub-tasks may not depend on one another. These further sub-tasks can be performed in parallel.

For example, a sub-task can depend on results from a plurality of other sub-tasks. Thus, the plurality of sub-tasks can be performed in parallel. However, the sub-task is performed after each of the plurality of other sub-tasks completes. In another example, a plurality of sub-tasks depends on results from a sub-task. Thus, the plurality of sub-tasks is performed after the sub-task completes. Different combinations of sub-task pluralities can also depend on another.

The completion of a task can be reflected in user data, such as, for example, in a user's calendar data, requisition date, expense report data, etc.

A schedule for calendar owner 308 can be represented in calendar data 392. Calendar owner 308 can define permissions 393 in PAD 394 to indicate privileges for other users (e.g., user 307) to access and/or modify calendar data 392.

In general, scheduling agent 391 can include the same functionality as scheduling agent 301. As such, scheduling agent 391 is configured to assist with completing scheduling tasks for calendar owner 308 (and possibly one or more other users). In response to receiving a request from another user to perform a task for calendar owner 308, scheduling agent 391 can refer to permissions 393 to determine if the other user is permitted to perform the task for calendar owner 308. Scheduling agent 391 can be integrated into a calendar program used by calendar owner 308.

In one aspect, task agent 301 receives scheduling task 311 from user 307. Scheduling task 311 can be a task for scheduling a meeting between user 307 and calendar owner 308. The request can include a time and location and can identify calendar owner 308. Task agent 301 can access workflow 312B (a workflow for scheduling meetings). Workflow 312B defines sub-tasks 313A, 313, 313C, etc. for scheduling task 311.

Task agent 301 can determine if automated task processing module 302 has capabilities to automate each of sub-tasks 313A, 313B, 313C, etc. For each sub-task, the determination can be based on scheduling task 311, asynchronous communication 321 with scheduling agent 391 and results (e.g., stored in results database 303) of previously performed sub-tasks. Asynchronous communication 321 can include sending a scheduling request for calendar owner 308 to scheduling agent 391 (and possibly sending a scheduling request other users and/or scheduling agents).

Upon receiving the scheduling request, scheduling agent 391 can refer to permissions 393 in PAD 394 to determine privileges for user 307. If user 307 has sufficient privileges, scheduling agent 391 permits the scheduling request and can enter an update to calendar data 392. On the other hand, if user 307 has does not sufficient privileges or if user 307 is not included din PAD 394, scheduling agent 391 denies the scheduling request. Alternatively, scheduling agent 391 notifies calendar owner 308 that user 307 requested scheduling task 311 and asks if it should be added to calendar data 392. Asynchronous communication 321 can also include a notification notifying user 307 if the scheduling request was permitted or denied. As such, when a virtual assistant (e.g., scheduling agent 101 or 391) receives a scheduling request from a user that is not included in a PAD for a calendar owner, the virtual assistant may still respond to the scheduling request. Instead of ignoring the request, the assistant contacts the calendar owner. The virtual assistant can send a message similar to “I received a requested from someone who is not privileged to meet next week. If you want, I can offer the following 3 times that are available in your calendar . . . otherwise I can politely decline the request or simply ignore it.”. In response to the message, the calendar owner can instruct the virtual assistant how to respond.

Notifying a calendar owner of requests from users not included in a PAD, can be useful for people who can get valid requests from strangers (e.g., real estate agents). These calendar owners could advertise their virtual assistant's contact info instead of their own (e.g., in their business cards or websites it could say something like “want to meet? Contact my assistant at foo@bar.com”).

Task agent 301 can determine that automated task processing module 302 has capabilities to automate sub-task 313A based on task 311, communication from one or more users (one or more of which may be calendar owners), etc., and results stored in results database 303. As such, task agent 301 can send sub-task 313A to automated task processing module 302.

Automated task processing module 302 can perform sub-task 313A and return results 314 to task agent 301. Results 314 can be stored in results database 303

Other automatable sub-tasks can be performed in a similar manner.

Task agent 301 can determine that automated task processing module 302 lacks capabilities to automate sub-task 313B based on task 311, communication from one or more users (one or more of which may be calendar owners), etc., and results stored in results database 303. As such, task agent 301 can escalate sub-task 313B to micro worker 304A. Micro worker 304A performs sub-task 313B and returns result 317 to task agent 301. Result 317 can be stored in results database 303.

Task agent 301 can also use result 317 to formulate feedback 312. Task agent 301 can send feedback 312 to automated task processing module 302 as training data. Automated task processing module 302 can use feedback 312 to train machine learning components. For example, feedback 312 can train machine learning components so that processing future instances of sub-task 313B (and/or or similar sub-tasks) can be automated.

Task agent 301 can also determine that automated task processing module 302 lacks capabilities to automate sub-task 313C based on task 311, communication from calendar owner 308 (and possibly other users) and results stored in results database 303. As such, task agent 301 can escalate sub-task 313C to micro worker 304B. However, micro worker 304B may be unable to complete sub-task 313C (e.g., due to lack of training, language skills, or other reasons). Micro worker 304B can return failure 328 to task agent 301 indicating an inability to process sub-task 313C.

When sub-task 313C cannot be performed by micro worker 304B, task agent 301 can escalate task 311 to macro worker 306A. Any remaining unperformed sub-tasks and results from previously performed sub-tasks can be sent to macro worker 306A. For example, results 316 (i.e., the collective results from automated and micro worker performed sub-tasks, including results 314 and 317) and sub-task 313C (as well as other unperformed sub-tasks defined in workflow 312B) can be sent to macro worker 306A. Macro worker 306A can complete performance of task 311. Result 318 from completing task 311 can be sent back to task agent 301. Task agent 301 can use result 318 to update data for user 307, such as, for example, with calendar update 310.

Completing task 311 can include asynchronous communication 321 and/or asynchronous communication 322. Task agent 301 can use asynchronous communication 321 to obtain information from calendar owner 308 (and possibly other users) for sub-task completion by automated task processing module 302 and/or micro workers 304. In other aspects, automated task processing module 302 and/or micro workers 304 can conduct asynchronous communication with calendar owner 308 (and possibly other users) (alternately or in addition to asynchronous communication 321).

Macro worker 306A can use asynchronous communication 322 to obtain information from calendar owner 308 (and possibly other users) to complete scheduling task 311.

Asynchronous communication 322 can include sending a scheduling request for calendar owner 308 to scheduling agent 391 (and possibly sending a scheduling request other users and/or scheduling agents) on behalf of user 307.

Upon receiving the scheduling request, scheduling agent 391 can refer to permissions 393 in PAD 394 to determine privileges for user 307. If user 307 has sufficient privileges, scheduling agent 391 permits the scheduling request and can enter an update to calendar data 392. On the other hand, if user 307 does not have sufficient privileges or (as described) is user 307 is not included in PAD 394, scheduling agent 391 denies the scheduling request. Alternatively, scheduling agent 391 notifies calendar owner 308 that user 307 requested scheduling task 311 and asks if it should be added to calendar data 392 (e.g., possibly also suggesting meeting times). Asynchronous communication 322 can also include a notification notifying macro worker 306A if the scheduling request was permitted or denied.

In one aspect, one or more users (e.g., calendar owners) have a task agent or scheduling agent that includes the combined functionality of task agent 301 and scheduling agent 391. The combined task agent or scheduling agent can initiate workflows to process tasks for the user as well as respond to scheduling requests from other users.

Accordingly, task and schedule processing can be highly automated using asynchronous communication between network connected agents. Automation facilitates more efficient use of computing resources and human resources, escalating tasks and sub-tasks when appropriate.

Additionally, the workload of macro workers is reduced by automated performance of sub-tasks and performance of sub-tasks by micro workers. As machine learning increases, workload of micro workers is also reduced by automated performance of sub-tasks. Accordingly, a three tiered approach of automation, micro workers, and macro workers is scalable and cost efficient while also providing flexibility to accurately handle more complex tasks and sub-tasks.

Various example uses are possible. The examples refer to a calendar owner, a user (the calendar owner's manager), and a virtual assistant. The calendar owner has identified the user as a privileged associate who can view his calendar and can automatically add items to his calendar without notification a day in advance, but with notification if the addition happens within the work day of when the event is to occur.

In one example, the user uses a voice command to ask the virtual assistant if the calendar owner is available at 2 pm that same afternoon. The virtual assistant refers to a PAD associated with the calendar owner, confirms privileges for the to view the calendar owner's calendar, and responds that the calendar owner is available. The user then emails the virtual assistant and the calendar owner scheduling a team meeting at 2 pm that afternoon. The virtual assistant refers to the PAD associated with the calendar owner and confirms the user's privileges. The virtual assistant then automatically adds the meeting on the calendar owner's schedule and sends a text notifying the calendar owner that a meeting has been added by the user for later that work day. Thus, a virtual assistant can use different types of electronic communication when scheduling an event.

In another example, the user emails the calendar owner and the virtual assistant that a team offsite is planned in three days. The virtual assistant refers to the PAD associated with the calendar owner and confirms the user's privileges to schedule such events regardless of conflict. The virtual assistant then then responds to both the calendar owner and the user via email that the offsite has been added to the calendar owner's calendar. However, given that the event is three days away, the virtual assistant does not text the calendar owner. The virtual assistant also attempts to reschedule two conflicting events on the calendar owner's calendar previously scheduled by the virtual assistant (and as such the virtual assistant has associated content information). The calendar owner also has two other conflicting events he scheduled himself. The virtual assistant emails the calendar owner to notify him of the conflicts.

In a further example, the user texts the calendar owner and the virtual assistant that a client would like to meet for dinner that night. The virtual assistant refers to the PAD associated with calendar owner and confirms the user has privileges to schedule events during the work day, but not after hours. The virtual assistant responds to both the calendar owner and the user via text that the calendar owner needs to confirm his availability that evening. The calendar owner responds via text that he is available. The virtual assistant automatically adds the event to the calendar owner's calendar and confirms his availability with the user via text message. Thus, a virtual assistant can be used to respond to different types of privileges and potential conflicts.

In one aspect, a system includes one or more processors, system memory, storage resources, and a scheduling agent. The system memory is coupled to the one or more processors and stores instructions that are executable by the processor. The one or more processors execute the instructions stored in the system memory to process a request to perform a scheduling related task for a calendar owner. The processor executes instructions to receive a request from a user to perform a scheduling related task for the calendar owner.

The processor executes instructions to access a privileged associates database for the calendar owner. The privileged associates database defines permissions for others to use the scheduling agent to perform scheduling-related tasks for the calendar owner. The processor executes instructions to determine privileges of the user to use the scheduling agent to perform the requested scheduling-related task for the calendar owner by referring to the defined permissions. The processor executes instructions to automatically, and without user intervention, synthesize a response to the request by transforming the request, the calendar owner's schedule, and determined privileges for the user into the response. The response is applicable to the calendar owner's calendar data. The processor executes instructions to respond to one or more of: the calendar owner, the calendar data, and the user in accordance with the response.

In another aspect, a method for processing a request to perform a scheduling-related task for a calendar owner is performed. A request to perform a scheduling-related task for the calendar owner is received from a user. A privileged associates database for the calendar owner is accessed. The privileged associates database defines permissions for others to use the scheduling agent to perform scheduling-related tasks for the calendar-owner. Privileges of the user to use the scheduling agent to perform the requested scheduling-related task for the calendar owner are determined by referring to the defined permissions. The request to perform the scheduling-related task is responded to in accordance with the calendar owner's schedule and determined privileges for the user.

In a further aspect, a computer program product for use at a computer system includes one or more computer storage devices having stored thereon computer-executable instructions that, in response to execution at a processor, cause the computer system to implement a method for processing a request to perform a scheduling-related task for a calendar owner. The computer program product includes computer-executable instructions that, in response to execution at a processor, cause the computer system to receive a request from a user to perform a scheduling-related task for the calendar owner.

The computer program product includes computer-executable instructions that, in response to execution at a processor, cause the computer system to access a privileged associates database for the calendar owner. The privileged associates database defines permissions for others to use the scheduling agent to perform scheduling-related tasks for the calendar owner. The computer program product includes computer-executable instructions that, in response to execution at a processor, cause the computer system to determine privileges of the user to use the scheduling agent to perform the requested scheduling-related task for the calendar owner by referring to the defined permissions. The computer program product includes computer-executable instructions that, in response to execution at a processor, cause the computer system to respond to the request to perform the requested scheduling-related task in accordance with the calendar owner's schedule and determined privileges for the user.

The present described aspects may be implemented in other specific forms without departing from its spirit or essential characteristics. The described aspects are to be considered in all respects only as illustrative and not restrictive. The scope is, therefore, indicated by the appended claims rather than by the foregoing description. All changes which come within the meaning and range of equivalency of the claims are to be embraced within their scope.

What is claimed:

1. A system, the system comprising:
one or more processors;
system memory coupled to one or more processors, the system memory storing instructions that are executable by the processor;
the one or more processors executing the instructions stored in the system memory to process a request to perform a scheduling related task for a calendar owner, including the following:
receive a request from a user to perform a scheduling related task for the calendar owner;
access a privileged associates database for the calendar owner, the privileged associates database defining permissions for others to use the scheduling agent to perform scheduling-related tasks for the calendar owner;
determine privileges of the user to use the scheduling agent to perform the requested scheduling-related task for the calendar owner by referring to the defined permissions;
automatically, and without user intervention, synthesize a response to the request by transforming the request, the calendar owner's schedule, and determined privileges for the user into the response, the response applicable to the calendar owner's calendar data; and
respond to one or more of: the calendar owner, the calendar data, and the user in accordance with the response.

2. The system of claim 1, wherein the one or more processors executing the instructions to receive a request from a user to perform a scheduling-related task for the calendar owner comprises the one or more processors executing the instructions to receive a request to schedule an event for the calendar user;
wherein the one or more processors executing the instructions to determine privileges of the user to use the scheduling agent comprises the one or more processors executing the instructions to determine that the user has sufficient privileges to use the scheduling agent to schedule the event for calendar owner; and
wherein the one or more processors executing the instructions to automatically, and without user intervention, synthesize a response to the request comprises the one or more processors executing the instructions to permit an attempt to schedule the event for the calendar owner.

3. The system of claim 2, wherein the one or more processors executing the instructions to permit an attempt to schedule the event for the calendar owner comprises the one or more processors executing the instructions to identify a conflict between the event and the calendar owner's schedule.

4. The system of claim 3, wherein the one or more processors executing the instructions to automatically, and without user intervention, synthesize a response to the request comprises the one or more processors executing the instructions to notify the user of the conflict.

5. The system of claim 3, wherein the one or more processors executing the instructions to automatically, and without user intervention, synthesize a response to the request comprises the one or more processors executing the instructions to:
notify the calendar owner of the conflict; and
notify the calendar owner that the user attempted to schedule event.

6. The system of claim 2, wherein the one or more processors executing the instructions permit an attempt to schedule the event for the calendar owner comprises a the one or more processors executing the instructions to schedule the event; and
wherein the one or more processors executing the instructions to respond to automatically, and without user intervention, synthesize a response to the request comprises the one or more processors executing the instructions to:
notifying the calendar owner of the scheduled event; and
notifying the calendar owner that the user scheduled event.

7. The system of claim 2, wherein the one or more processors executing the instructions to permit an attempt to schedule the event for the calendar owner comprises a the one or more processors executing the instructions to schedule the event; and
wherein the one or more processors executing the instructions to automatically, and without user intervention, synthesize a response to the request comprises the one or more processors executing the instructions to notify the user of the scheduled event.

8. The system of claim 2, wherein the one or more processors executing the instructions to determine privileges of the user to use the scheduling agent comprises the one or more processors executing the instructions to determine that the user has insufficient privileges to schedule the event for the calendar owner; and
wherein the one or more processors executing the instructions to automatically, and without user intervention, synthesize a response to the request comprises the one or more processors executing the instructions to prevent an attempt to schedule the event for the calendar owner.

9. The system of claim 1, further comprising the one or more processors executing the instructions to:
receive a request from the user to read the calendar owner's schedule;
determine that the user has view access the calendar owner's calendar by referring to the defined permissions; and
provide a view of the calendar owner's schedule to the user in response to the request.

10. The system of claim 9, the one or more processors executing the instructions to determine that the user has view to access the calendar owner's calendar by referring to the defined permissions comprises the one or more processors executing the instructions to determine that the user is a privileged associate of the calendar owner.

11. The system of claim 9, wherein the one or more processors executing the instructions to determine that the user has view access the calendar owner's calendar by referring to the defined permissions comprises the one or more processors executing the instructions to determine that the user is associated with a specified domain.

12. The system of claim 9, wherein the one or more processors executing the instructions to provide a view of the calendar owner's schedule to the user in response to the request comprises the one or more processors executing the instructions to provide a snapshot of the calendar owner's calendar to the user.

13. The system of claim 9, wherein the one or more processors executing the instructions to provide a view of the calendar owner's schedule to the user in response to the request comprises the one or more processors executing the instructions to indicate the calendar owner's free time and the calendar owner's busy time to the user.

14. A method for use at a computer system, the computer system including a processor and a scheduling agent, the method for using the processor to process a request to perform a scheduling related task for a calendar owner, the method comprising:
receiving a request from a user to perform a scheduling-related task for the calendar owner;
accessing a privileged associates database for the calendar owner, the privileged associates database defining permissions for others to use the scheduling agent to perform scheduling-related tasks for the calendar owner;
determining privileges of the user to use the scheduling agent to perform the requested scheduling-related task for the calendar owner by referring to the defined permissions; and
responding to the request to perform the requested scheduling-related task in accordance with the calendar owner's schedule and determined privileges for the user.

15. The method of claim 14, wherein receiving a request from a user to perform a scheduling-related task for the calendar owner comprises receiving a request to schedule an event for the calendar owner; and
wherein determining privileges of the user to use the scheduling agent comprises determining that the user has sufficient privileges to use the scheduling agent to schedule the event for the calendar owner; and
wherein responding to the request to perform the requested scheduling-related task comprises permitting the scheduling agent to attempt to schedule the event for the calendar owner.

16. The method of claim 15, wherein permitting the scheduling agent to attempt to schedule the event for the calendar owner comprises identifying a conflict between the event and the calendar owner's schedule; and
wherein responding to the request to perform the requested scheduling-related task comprises:
notifying the user of the conflict;
notifying the calendar owner of the conflict; and
notifying the calendar owner that the user attempted to schedule event.

17. The method of claim 15, wherein permitting the scheduling agent to attempt to schedule the event for the calendar owner comprises scheduling the event; and
wherein responding to the request to perform the requested scheduling-related task comprises:
notifying the calendar owner of the scheduled event; and
notifying the calendar owner that the user scheduled event.

18. The method of claim 14, further comprising:
receiving a request from the user to read the calendar owner's schedule;
determining that the user has view access the calendar owner's calendar by referring to the defined permissions; and
providing a view of the calendar owner's schedule to the user in response to the request.

19. The method of claim 18, wherein determining that the user has view access to the calendar owner's calendar by referring to the defined permissions comprises determining that the user is one of: a privileged associate of the calendar owner or is associated with a specified domain;
wherein providing a view of the calendar owner's schedule to the user in response to the request comprises providing a snapshot of the calendar owner's calendar to the user, the snapshot indicating the calendar owner's free time and the calendar owner's busy time to the user.

20. A computer program product for use at a computer system, the computer program product for implementing a method for processing a request to perform a scheduling-related task for a calendar owner, the computer program product comprising one or more computer storage devices having stored thereon computer-executable instructions that, when executed at a processor, cause the computer system to implement the method, including the following:
receive a request from user to perform a scheduling-related task for the calendar owner;
access a privileged associates database for the calendar owner, the privileged associates database defining permissions for others to use the scheduling agent to perform scheduling-related tasks for the calendar owner;
determine privileges of the user to use the scheduling agent to perform the requested scheduling-related task for the calendar owner by referring to the defined permissions; and
respond to the request to perform the requested scheduling-related task in accordance with the calendar owner's schedule and determined privileges for the user.
